(19) United States
(12) Patent Application Publication
(10) Pub. No.: US 2025/0192242 A1
(43) Pub. Date: Jun. 12, 2025

(54) POST-FORMATION ELECTROLYTE REFILLING

(71) Applicant: FORD GLOBAL TECHNOLOGIES, LLC, Dearborn, MI (US)

(72) Inventors: Liyuan SUN, Ann Arbor, MI (US); Eunsung LEE, Novi, MI (US); Chi PAIK, Grosse Ile, MI (US)

(21) Appl. No.: 18/536,311

(22) Filed: Dec. 12, 2023

(51) Int. Cl. H01M 10/42; H01M 10/0525; H01M 10/0567; H01M 10/0568; H01M 10/0569; H01M 10/058; H01M 10/44; H01M 50/609

(52) U.S. Cl. CPC H01M 10/4235; H01M 10/0525; H01M 10/0567; H01M 10/0568; H01M 10/0569; H01M 10/058; H01M 10/44; H01M 50/609; H01M 2300/0034; H01M 2300/0037

(57) ABSTRACT

A lithium-ion battery cell is provided along with a process for its preparation. The method involves first saturating the cell's anode, cathode, and separator with a carbonate-based electrolyte to form a lithium fluoride-rich passivation layer. Subsequently, this electrolyte is flushed and replaced by a soft solvents-based electrolyte. This two-step electrolyte process may help form a more robust initial passivation layer.

### TECHNICAL FIELD

This disclosure relates to lithium-ion batteries and electrolytes used in lithium-ion batteries.

### BACKGROUND

Lithium-ion batteries typically employ carbonate-based electrolytes, which may present limitations. The operational parameters of lithium-ion batteries with traditional carbonate-based electrolytes are typically limited to a voltage ceiling of 4.3V and a temperature band of −20° C. to 50° C. This may be due to the increased occurrence of lithium plating at temperatures below −20° C., where the electrolytes exhibit low ionic conductivity and high charge transfer resistance.

Soft solvents-based electrolytes may have expanded operation voltage and temperature ranges. However, long-term calendar life of batteries at elevated temperatures (45° C. or above) remain unaddressed and potentially challenging. This is primarily due to the formation of thin layers of cathode and anode solid/electrolyte interfaces (cathode electrolyte interface and solid electrolyte interface, respectively) within the electrolyte environment.

### SUMMARY

In one aspect, a method for preparing a lithium-ion battery cell includes saturating the cell's anode, cathode, and separator with a carbonate-based electrolyte to form a lithium fluoride-rich passivation layer between the anode and separator, providing electronic insulation and ionic conduction. This is followed by flushing out the carbonate-based electrolyte with a soft solvents-based electrolyte, leaving the latter within the cell.

The carbonate-based electrolyte may contain various lithium salts dissolved within, such as lithium hexafluorophosphate, lithium bis(fluorosulfonyl)imide, lithium bis(trifluoromethanesulfonyl)imide, lithium bis(oxalate)borate, and lithium tetrafluoroborate. Additives in the carbonate-based electrolyte can include vinylene carbonate, fluoroethylene carbonate, and similar compounds that enhance battery performance.

The soft solvents-based electrolyte comprises methyldifluoroacetate, methyldifluoro(sulfonyl)acetate, and may further include a diluent such as 1,1,2,2-tetrafluoroethyl-2,2,3,3-tetrafluoropropylether. During the flushing step, the volume of the soft solvents-based electrolyte is maintained relative to the total porosity of the electrodes and separator.

The method may also involve one or more sealing steps post-saturation and post-flushing. Additionally, the saturating step may incorporate a formation process with at least one cycle of charge and discharge, which may be followed by a second cycle to a different state of charge.

A lithium-ion battery cell prepared by this method comprises a cathode, a current collector, a soft solvents-based electrolyte, and an anode with a pre-formed lithium fluoride-rich passivation layer. The cathode may comprise a nickel manganese cobalt oxide material with a specified composition ratio, particularly 8:1:1 for nickel, manganese, and cobalt.

The battery cell may be designed in prismatic or cylindrical forms. The soft solvents-based electrolyte within the cell features a mixture of fluorinated esters and ethers, containing dissolved lithium salts such as lithium hexafluorophosphate, lithium bis(fluorosulfonyl)imide, lithium bis(trifluoromethanesulfonyl)imide, and lithium nitrate.

### BRIEF DESCRIPTION OF THE DRAWINGS

FIG. 1 is a flowchart of an assembly process according to one embodiment; and

FIG. 2 is a schematic of a lithium-ion battery cell according to one embodiment.

### DETAILED DESCRIPTION

Embodiments are described herein. It is to be understood, however, that the disclosed embodiments are merely examples and other embodiments may take various and alternative forms. The figures are not necessarily to scale. Some features could be exaggerated or minimized to show details of particular components. Therefore, specific structural and functional details disclosed herein are not to be interpreted as limiting, but merely as a representative basis for teaching one skilled in the art.

Various features illustrated and described with reference to any one of the figures may be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Electrolytes based on “soft solvents” may extend the operational limits of lithium-ion batteries. The use of fluorinated acetates, such as methyldifluoroacetate and methyldifluoro(sulfonyl)acetate, has enabled the operation of lithium-ion battery cells composed of nickel manganese cobalt oxide (NMC) with a chemical composition ratio of 8:1:1 for nickel (Ni), manganese (Mn), and cobalt (Co) as the cathode material, and graphite as the anode material at voltages up to 4.5V and temperatures as low as −60° C. The higher electrochemical stability of the soft solvents may reduce the degradation and extend the voltage range of the battery.

The soft solvents exhibit a well-balanced donor number and dielectric constant, which leads to lower lithium-ion desolvation energy and, consequently, reduced charge transfer resistance at lower temperatures. Lithium plating is suppressed due to the decreased desolvation energy and the formation of lithium-fluoride (Li—F) rich interfaces, which may help to maintain battery integrity at temperature extremes.

The performance parameters of lithium-ion batteries (LiBs) may be increased through a dual-electrolyte refilling process. The process involves the initial filling and formation of LiBs with a conventional carbonate-based electrolyte containing specific salts and additives. The purpose of this initial step may be to establish Li—F rich interfaces that exhibit necessary thickness for robustness. This initial formation may increase the long-term life and stability of the LiBs when operated at elevated temperatures.

Once the LiBs have been fully formed with the conventional electrolyte, a transition to a second electrolyte takes place. This second electrolyte may be comprised of soft solvents, which may include, but are not limited to, methyldifluoroacetate and methyldifluoro(sulfonyl)acetate. The substitution of the first electrolyte with the second is done to increase the LiB's ability to function more effectively at higher voltages and lower temperatures. The increased electrochemical stability of the soft solvents and the reduced desolvation energy of lithium ions (Li+) within these solvents are contributors to increased performance.

Furthermore, the second electrolyte may incorporate a diluent such as 1,1,2,2-tetrafluoroethyl-2,2,3,3-tetrafluoropropylether (TTE). This combination may not decrease the long-term performance at high temperatures, which is maintained by the Li—F rich interfaces formed during the initial electrolyte formation.

The initial carbonate-based electrolyte is flushed out and replaced by the second soft solvents-based electrolyte while preserving the same excess volume relative to the total porosity of the electrodes and separator within the LiBs. This may help maintain the designed electrochemical characteristics of the LiBs through the electrolyte refilling process.

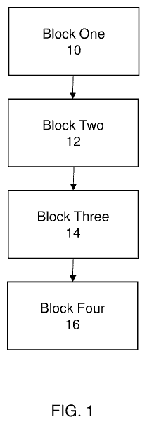

FIG. 1 presents a flowchart of a lithium-ion battery cell undergoing a dual-electrolyte refilling process. In Block One 10, a lithium-ion battery cell is filled with a carbonate-based electrolyte, which may saturate a jelly roll area. The jelly roll is the cell's internal wound electrode structure comprising layers of anode, cathode, and separator. The cathode may comprise a nickel manganese cobalt oxide material with a chemical composition ratio of 8:1:1 for nickel, manganese, and cobalt. The carbonate-based electrolyte facilitates the formation of a solid-electrolyte interface (SEI) on the electrode, which is a step comprising the formation process and results in an electronically insulating and ionically conducting lithium fluoride-rich passivation layer. In some configurations the formation step may comprise at least one cycle of charge and discharge and a second cycle of charge and discharge to a different state of charge from the first cycle. The carbonate-based electrolyte contains salts selected from a group consisting of lithium hexafluorophosphate, lithium bis(fluorosulfonyl)imide, lithium bis(trifluoromethanesulfonyl)imide, lithium bis(oxalate)borate, and lithium tetrafluoroborate, and may further comprise additives selected from a group consisting of vinylene carbonate, fluoroethylene carbonate, 1,3-propane sultone, 1,3,2-dioxathiolane-2,3-dioxide, 1,3-Propanediol cyclic sulfate, and adiponitrile. The battery cell may be a prismatic or a cylindrical battery cell.

After the SEI formation, the cell is subjected to a first sealing process in Block Two 12. This step encapsulates the electrolyte and electrode assembly, which may help maintain the integrity of the formed SEI layer and isolate it from external influences. Following the initial sealing and formation, in Block Three 14 the cell is flushed with a soft solvents-based electrolyte to remove the carbonate-based electrolyte entirely, the SEI remains intact and the internal structure, including the jelly roll, is unaltered. The flushing step maintains the same excess volume of electrolyte relative to the total porosity of the electrodes and separator. The soft solvents may comprise materials such as methyldifluoroacetate and methyldifluoro(sulfonyl)acetate and may also be mixed with diluents such as TTE. These solvents are selected for their higher electrochemical stability, which may allow the battery to operate at voltages up to 4.5V and temperatures as low as −60° C. Block Four 16 is a second sealing step, and indicates the completion of the battery cell.

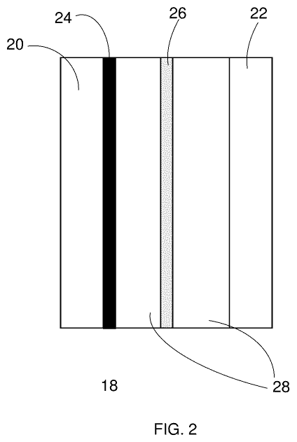

FIG. 2 is a schematic illustration of a lithium-ion battery cell 18, comprising an anode 20, and a cathode 22 with an SEI layer 24. The anode and cathode are separated by a separator 26, and the cell 18 has a soft solvents-based electrolyte 28. The SEI layer 24 is formed during the initial electrolyte filling and formation process, and is a lithium fluoride-rich passivation layer that is both electronically insulating and ionically conducting. The soft solvents-based electrolyte 28 is introduced after the SEI layer 24 formation and is selected for its electrochemical stability. This electrolyte 28 may contain a mixture of compounds such as methyldifluoroacetate and may also be combined with diluents like TTE, chosen for their low-temperature fluidity and compatibility with the SEI layer 24.

The algorithms, methods, or processes disclosed or suggested herein may be deliverable to or implemented by a computer, controller, or processing device, which can include any dedicated electronic control unit or programmable electronic control unit. Similarly, the algorithms, methods, or processes may be stored as data and instructions executable by a computer or controller in many forms including, but not limited to, information permanently stored on non-writable storage media such as read only memory devices and information alterably stored on writeable storage media such as compact discs, random access memory devices, or other magnetic and optical media. The algorithms, methods, or processes may also be implemented in software executable objects. Alternatively, the algorithms, methods, or processes may be embodied in whole or in part using suitable hardware components, such as application specific integrated circuits, field-programmable gate arrays, state machines, or other hardware components or devices, or a combination of firmware, hardware, and software components.

While exemplary embodiments are described above, it is not intended that these embodiments describe all possible forms encompassed by the claims. The words used in the specification are words of description rather than limitation, and it is understood that various changes may be made without departing from the spirit and scope of these disclosed materials.

As previously described, the features of various embodiments may be combined to form further embodiments of the disclosure that may not be explicitly described or illustrated. While various embodiments could have been described as providing advantages or being preferred over other embodiments or prior art implementations with respect to one or more desired characteristics, those of ordinary skill in the art recognize that one or more features or characteristics may be compromised to achieve desired overall system attributes, which depend on the specific application and implementation. These attributes may include, but are not limited to strength, durability, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and may be desirable for particular applications.

What is claimed is:

1. A method comprising:
saturating an anode, cathode, and separator of a lithium-ion battery cell with a carbonate-based electrolyte such that an electronically insulating and ionically conducting lithium fluoride rich passivation layer forms between the anode and separator; and
flushing the lithium-ion battery cell of the carbonate-based electrolyte with a soft solvents-based electrolyte such that the soft solvents-based electrolyte remains in the lithium-ion battery cell.

2. The method of claim 1, wherein the carbonate-based electrolyte contains salts selected from a group consisting of lithium hexafluorophosphate, lithium bis(fluorosulfonyl)imide, lithium bis(trifluoromethanesulfonyl)imide, lithium bis(oxalate)borate, and lithium tetrafluoroborate.

3. The method of claim 1, wherein the carbonate-based electrolyte further comprises additives selected from a group consisting of vinylene carbonate, fluoroethylene carbonate, 1,3-propane sultone, 1,3,2-dioxathiolane-2,3-dioxide, 1,3-Propanediol cyclic sulfate, and adiponitrile.

4. The method of claim 1, wherein the soft solvents-based electrolyte comprises methyldifluoroacetate and methyldifluoro(sulfonyl)acetate.

5. The method of claim 1, wherein the soft solvents-based electrolyte further comprises a diluent 1,1,2,2-tetrafluoroethyl-2,2,3,3-tetrafluoropropylether.

6. The method of claim 1, wherein the flushing maintains a same excess volume of electrolyte relative to a total porosity of the anode, cathode, and separator.

7. The method of claim 1 further comprising sealing the lithium-ion battery cell after the saturating.

8. The method of claim 7 further comprising sealing the lithium-ion battery cell after the flushing.

9. The method of claim 1, wherein the saturating includes a formation process that comprises at least one cycle of charge and discharge.

10. The method of claim 9, wherein the formation process further comprises a second cycle of charge and discharge to a different state of charge than a first cycle of charge and discharge.

11. A lithium-ion battery cell comprising:
a cathode;
an anode with an electronically insulating and ionically conducting lithium fluoride rich passivation layer formed by a carbonate-based electrolyte; and
a soft solvents-based electrolyte saturating the cathode and anode.

12. The lithium-ion battery cell of claim 11, wherein the soft solvents-based electrolyte comprises methyldifluoroacetate and methyldifluoro(sulfonyl)acetate.

13. The lithium-ion battery cell of claim 11, wherein the soft solvents-based electrolyte further comprises a diluent 1,1,2,2-tetrafluoroethyl-2,2,3,3-tetrafluoropropylether.

14. The lithium-ion battery cell of claim 11, wherein the carbonate-based electrolyte further comprises additives selected from a group consisting of vinylene carbonate, fluoroethylene carbonate 1,3-propane sultone, 1,3,2-dioxathiolane-2,3-dioxide, 1,3-Propanediol cyclic sulfate, and adiponitrile.

15. The lithium-ion battery cell of claim 11, wherein the carbonate-based electrolyte further comprises additives selected from a group consisting of vinylene carbonate, fluoroethylene carbonate, 1,3-propane sultone, 1,3,2-dioxathiolane-2,3-dioxide, 1,3-Propanediol cyclic sulfate, and adiponitrile.

16. The lithium-ion battery cell of claim 11, wherein the cathode comprises a nickel manganese cobalt oxide material with a chemical composition ratio of 8:1:1 for nickel, manganese, and cobalt.

17. The lithium-ion battery cell of claim 11, wherein the cell is a prismatic cell.

18. The lithium-ion battery cell of claim 11, wherein the cell is a cylindrical cell.

19. A lithium-ion battery cell comprising:
a cathode;
an anode having a carbonate-based electrolyte generated lithium fluoride rich passivation layer;
a separator between the cathode and anode; and
a soft solvents-based electrolyte, with a lithium salt dissolved in a mixture of solvents comprising fluorinated esters and ethers, saturating the cathode and anode.

20. The lithium-ion battery cell of claim 19, wherein the lithium salt is selected from the group consisting of lithium hexafluorophosphate, lithium bis(fluorosulfonyl)imide, lithium bis(trifluoromethanesulfonyl)imide, and lithium nitrate.
